(19) United States
(12) Patent Application Publication
(10) Pub. No.: US 2025/0324337 A1
(43) Pub. Date: Oct. 16, 2025

(54) POLY-MODULE FREQUENCY RANGE ALIGNMENT

(71) Applicant: Meta Platforms Technologies, LLC, Menlo Park, CA (US)

(72) Inventors: Abhishek Kumar Agrawal, Bellevue, WA (US); Jaiyoung Park, Sunnyvale, CA (US); Raejoon Jung, Foster City, CA (US); Chien-Ming Nieh, Palo Alto, CA (US); Justin Michael Davis, Bellevue, WA (US); Nathaniel Storer, Pacifica, CA (US)

(21) Appl. No.: 18/634,861

(22) Filed: Apr. 12, 2024

(51) Int. Cl. H04W 36/20; H04L 5/00; H04W 36/06; H04W 72/0453; H04W 72/541

(52) U.S. Cl. CPC H04W 36/20; H04W 36/06; H04W 72/0453; H04W 72/541; H04L 5/0005

(57) ABSTRACT

The disclosed system may include a user device with (1) a first module, which performs a first functionality, and (2) a second module, which performs a second functionality, (3) a physical processor, and (4) physical memory including computer-executable instructions that cause the physical processor to (i) determine that a change in a range of frequency, being used by the first module, has resulted, or will result, in interference between the first module's changed range of frequency and a range of frequency being used by the second module, and (ii) in response to the determining that the change in the range of frequency has resulted in the interference, change the range of the frequency being used by the second module to a new range of frequency that does not interfere with the first module's changed range of frequency. Various other wearable devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system 100 for poly-module frequency range alignment (e.g., between a first module and a second module within a user device).

FIG. 2 depicts an exemplary method for poly-module frequency range alignment (e.g., corresponding to the elements of FIG. 1).

FIG. 3 depicts an exemplary wearable user device (i.e., in which the wearable user device is a pair of glasses).

FIG. 4 depicts another exemplary wearable user device (i.e., in which the wearable user device is a headset).

FIG. 5 depicts another exemplary wearable user device (i.e., in which the wearable user device is a watch).

FIG. 6 depicts an exemplary time interval with multiple time slots, each of which corresponds to a different task.

FIG. 7 depicts an exemplary method for poly-module frequency range alignment (e.g., that represents one exemplary implementation of the method of FIG. 2).

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This application is generally directed to a system for mitigating interference in user devices (e.g., wearable devices) that include both a first module (e.g., a camera module) and a second module (e.g., an antenna module) that are placed near one another (e.g., at a distance at which the activities of one module may cause interference with the other).

The modern user device is expected to perform many functions while taking up very little space. This may be especially true in the context of wearable devices (e.g., artificial reality headsets). As a result, designs for user devices may require a first module, such as a camera module, to operate very nearby a second module, such as an antenna (e.g., WiFi) module (e.g., at a proximity at which the signals transmitted and/or received by one module may cause interference for the signals transmitted and/or received by the other module). One solution identified by this application is a poly-module optimization system that configures proximately placed modules to send and receive signals at different ranges of frequencies (e.g., such that the signals in the frequency range selected for one module do not interfere with the signals in the frequency range selected for another module). This solution allows multiple modules to operate contemporaneously (e.g., without interfering with one another's signals).

In many instances, the optimal range of frequencies for a particular module may change over time. This change may be caused by a variety of events. As a specific example, an WiFi module's optimal range of frequency may change when a WiFi source changes. In some examples, the change may cause a domino effect (e.g., a first module may change to a new frequency range that interferes with a current frequency range of a second module, causing a need to change the frequency range of the second module). Returning to our specific example, a new frequency range selected for a WiFi module (e.g., in response to a change in WiFi source) may conflict with a current frequency range of a camera module, necessitating a change in the frequency range of the camera module.

This application identifies that, in some instances, changing a module's frequency range may cause a momentary disruption to the module (e.g., during which performance of the module is decreased by some metric). Responding to this observation, the disclosed poly-module optimization system may determine an optimal moment at which to change a module's frequency range (e.g., a moment at which the decrease in performance will be least disruptive to a general and/or specific performance of the user device).

As a specific example, a camera module may be configured to capture a series of frames at different time slots. Each time slot may be associated with a different operation performed by the user device and the frame captured during a given time slot may be used as input for the given time slot's corresponding operation. In this specific example, the poly-module optimization system may be configured to change a frequency range of the camera module at a time slot corresponding to an operation designated as less important than one or more of the operations corresponding to other time slots. In one such example, each time slot may correspond to a different type of tracking (e.g., head-tracking, controller-tracking, hand-tracking, keyboard-tracking, etc.) and the selected time slot may correspond to a type of tracking (e.g., keyboard-tracking) designated as less important (e.g., less noticeable to an end-user) relative to the other types of tracking.

Features from any of the embodiments described herein may be used in combination with one another in accordance with the general principles described herein. These and other embodiments, features, and advantages will be more fully understood upon reading the following detailed description in conjunction with the accompanying drawings and claims.

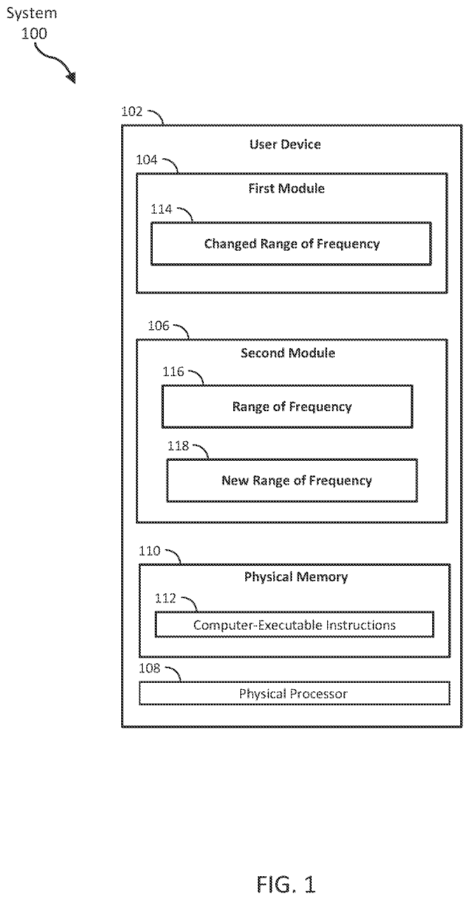

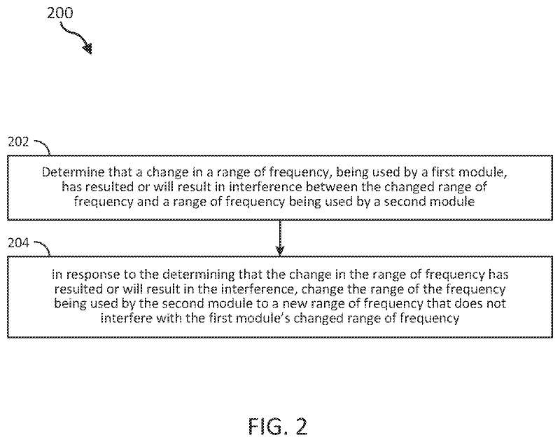

FIG. 1 illustrates an embodiment of a system 100 with a user device 102 that includes a first module 104, which performs a first functionality for user device 102, and a second module 106, which performs a second functionality for user device 102. Additionally, user device 102 may include a physical processor 108 and physical memory 110 with computer-executable instructions 112 that cause physical processor 108 to perform the steps described herein (e.g., in connection with the method of FIG. 2).

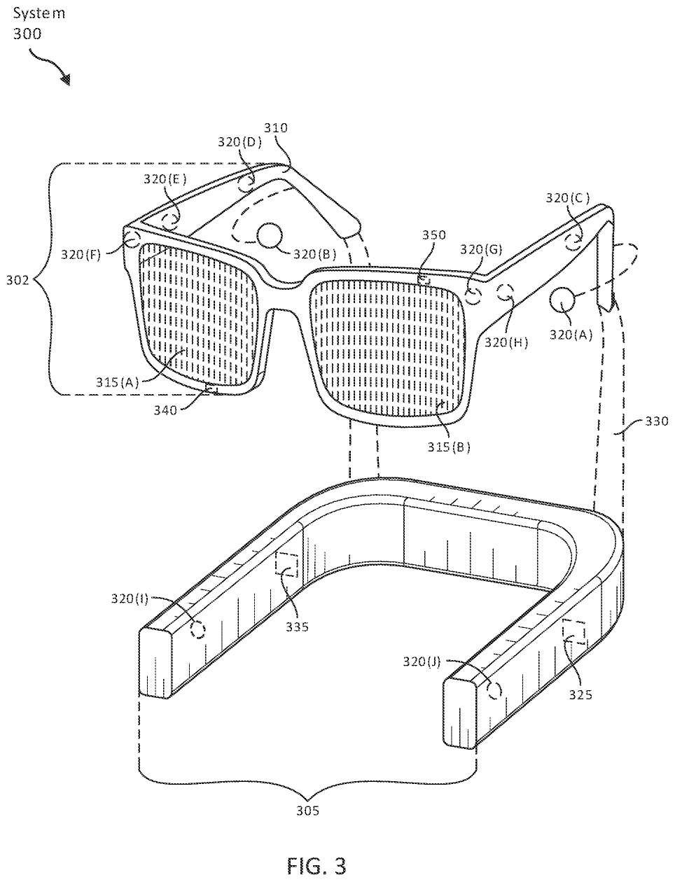

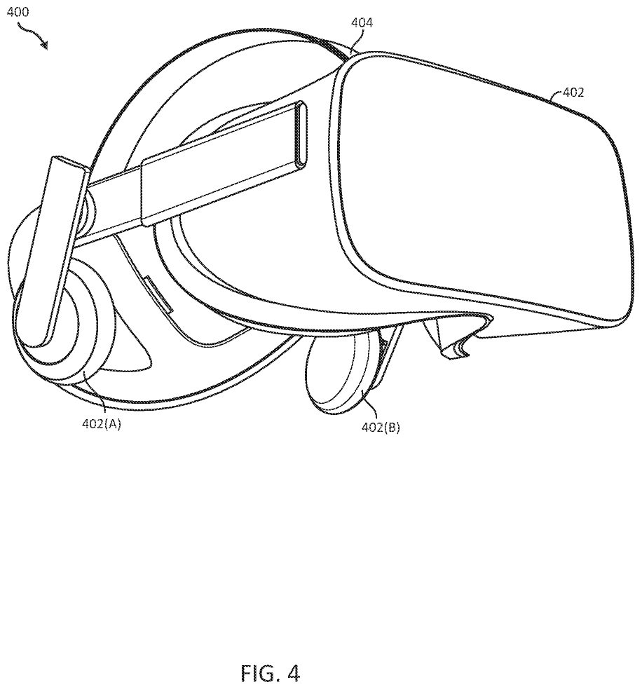

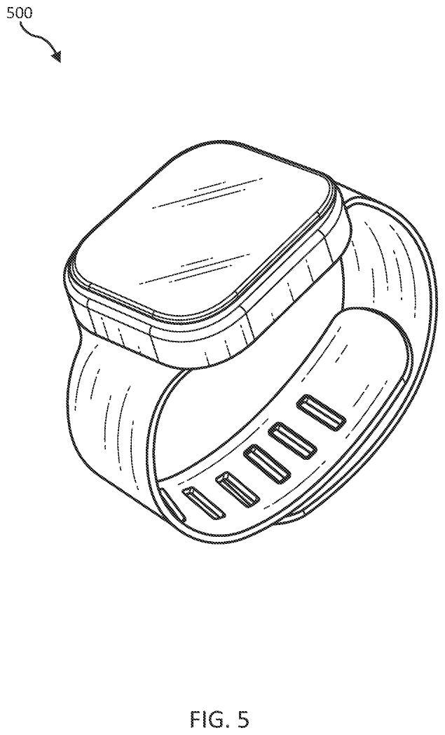

User device 102 generally represents any type or form of computing device capable of reading computer-executable instructions. In some examples, user device 102 may represent a wearable device. For example, user device 102 may represent a head-worn wearable device such as a pair of glasses, (e.g., augmented-reality system 300 as depicted in FIG. 3) and/or a headset (e.g., virtual-reality system 400 as depicted in FIG. 4) and/or may represent a watch (e.g., watch 500 as depicted in FIG. 5). In some examples, user device 102 may represent an artificial reality device. Exemplary features of user device 102 in such examples will be discussed later in connection with FIGS. 3 and 4. In some examples, user device 102 may represent a smart phone and/or a tablet. Additional examples of user device 102 may include, without limitation, a laptop, a desktop, a wearable device, a personal digital assistant (PDA), etc.

First module 104 may represent any combination of hardware and/or software that performs one or more tasks relating to a particular functionality of user device 102. In some examples, first module 104 may transmit and/or receive data (e.g., to one or more additional modules within user device 102 and/or to one or more external devices) using electromagnetic waves. For example, first module 104 may convert digital data into electromagnetic waves, transmit the digital data to other devices by radiating the electromagnetic waves, receive digital data from other devices by intercepting radiated electromagnetic waves, and/or decode intercepted radiated electromagnetic waves. In some such examples, first module 104 may have the capability of operating (e.g., sending/receiving electromagnetic waves) from a broad spectrum of frequencies. The term “broad spectrum of frequencies” may refer to a spectrum that includes multiple different ranges of frequencies at which a module may operate. The term “range of frequency” (e.g., frequency band, frequency range, clock frequency, and/or clock rate) may refer to a range of electromagnetic wave frequencies that falls within a larger spectrum of ranges (e.g., a subrange of a larger range). In such examples, first module 104 may have the capability of switching from operating at a first range of frequency (e.g., transmitting and/or receiving data using electromagnetic waves frequencies in the first range) to operating at a second range of frequency (e.g., transmitting and/or receiving data using electromagnetic waves frequencies in the second range). In these examples, one or both ends of the first and second ranges may differ from one another.

First module 104 may represent a module directed to any type or form of function (e.g., that involves transmitting and/or receiving electromagnetic wave frequencies). Specific examples of first module 104 include, without limitation, an antenna module (e.g., a WiFi module and/or a Bluetooth module), a camera module, a GPS module, a cellular module, an RFID (radio frequency identification) module, a heart rate monitor module, a sensor module, etc. Second module 106 may include any of the features described herein in connection with first module 104 and may represent any type or form of module (e.g., such as one or more of the module types just described in connection with first module 104). In one specific example, first module 104 may represent a WiFi module (e.g., configured to connect to wireless networks and transmit and/or receive data via wireless networks) and second module 106 may represent a camera module (e.g. configured to capture and/or process image data).

A WiFi module may refer to any type or form of module that performs one or more tasks relating to connecting to a wireless network and/or transmitting and/or receiving data via a wireless network. As might be inferred, the WiFi module may include an antenna and/or antenna-specific software. In some examples, a WiFi module may include a vast spectrum of frequencies at which the WiFi module may operate (e.g., at which the WiFi module may radiate and/or receive data). As specific example, a WiFi module may radiate and/or receive electromagnetic waves at any frequency range within a spectrum supported by 6G wireless communication technology. In some examples, the WiFi module may be configured to change the frequency range at which the WiFi module is operating dynamically. For example, the WiFi module may be configured to (1) identify and select an available WiFi network to which to connect, (2) identify a range of frequency at which the WiFi network is operating, and (3) radiate and receive electromagnetic waves to and from the WiFi network at the range of frequency at which the WiFi network is operating. A WiFi module may be configured to change from one WiFi network to another in response to a variety of triggers (e.g., loss of connection with a current WiFi network, determining that a new WiFi network offers a stronger connection than a current WiFi network, a change in environment, etc.). Thus, in some examples, a WiFi module may represent a module that (1) can radiate and receive electromagnetic waves from anywhere within a vast spectrum (e.g., such that other modules cannot simply be configured to operate at a range that falls outside of the WiFi module's spectrum) and (2) is highly variable (e.g., changes its operating frequency range frequently).

A camera module may represent any type or form of computer-implemented module involved in capturing and/or processing image data (e.g., real-world image data). As may be inferred, in some examples a camera module can include both a digital camera (for capturing images) and software (e.g., for processing image data). In some examples, a camera module, operating within user device 102, may be configured to alternate between capturing frames for different purposes. In one such example, the camera module may alternate between capturing frames for different purposes using Time-Division Multiplexing (TDM). In these examples, the camera module may capture frames (e.g., images) intended for different operations using a common camera (e.g., such that only a fraction of the frames captured by the camera are for a given operation and frames, for different operations, are captured in an alternating pattern).

In one example in which the camera module alternates between capturing frames for different purposes, the camera module may be configured to capture multiple frames within a certain interval of time (a time interval in which there are multiple time slots). In this example, each frame may be captured at a different time slot within the interval of time. Each time slot may correspond to different type of operation and each frame may be captured as input for the type of operation corresponding to the time slot at which the frame is captured. As a specific example, the camera module (e.g., second module 106) may operate within a wearable device (e.g., user device 102) and may be configured to alternate between capturing frames for different tracking engines, each of which tracks a different designated entity in an environment of the wearable device. In one embodiment, the camera module may capture images for (1) a first tracking engine configured to process a first type of tracking (e.g., controller tracking, head tracking, etc.) and (2) a second tracking engine configured to process a second type of tracking (e.g., keyboard tracking)). While this specific example focuses on an embodiment in which there are two tracking engines, it should be appreciated that the camera module may capture images intended for any number of tracking engines.

In some examples in which the camera module captures frames for different operations (e.g., tracking engines), the features (e.g., settings) of the frames may differ from one another. For example, one frame (e.g., captured using Time-Division Multiplexing) may be captured for a bright-frame tracking engine that processes bright frames (e.g., frames that capture pixels above a threshold brightness) and another frame may be captured for a dark-frame tracking engine that processes dark frames (e.g., frames that capture pixels below a threshold brightness). In this example, the camera module may alternate between capturing bright frames, to be processed by a bright-frame tracking engine, and dark frames, to be processed by a dark-frame tracking engines.

In some examples, first module 104 and second module 106 may be proximately placed (e.g., positioned) within user device 102 (e.g., within a printed circuit board of user device 102). The term “proximately placed” may refer to modules that are placed at a proximity at which the electromagnetic waves of one module may cause interference for the other (e.g., degrading the performance of the other module). In some examples, the term “interference” may refer to disruption to a signal (e.g., caused by another signal).

One solution to this issue is to configure each module to operate at frequency range that does not interfere with the frequency range of the other module, configuring the modules to operate at non-interfering (e.g., non-overlapping) frequency ranges. However, with the advent of more robust communication technologies, this strategy may be difficult or impossible to implement. For example, to take full advantage of wide-ranged wireless communication technologies (e.g., 6G wireless communication), a WiFi module must also operate at a wide-range, making it difficult or impossible to find a range that falls outside of the wide-range used for the WiFi module. Responding to this computer problem, which has emerged from advances in technology, the instant application provides a poly-module framework that dynamically alternates the frequency ranges being used by proximately placed modules to ensure the modules are always operating at non-interfering frequencies (e.g., frequencies that do not result in interference) and/or at frequencies that mitigate inter-frequency interference.

FIG. 2 is a flow diagram of an exemplary computer-implemented method 200 for mitigating inter-module signal interference. The steps shown in FIG. 2 may be performed by any suitable computer-executable code and/or computing system, including the system(s) illustrated in FIG. 1. For example, the steps shown in FIG. 2 may be performed by modules operating in user device 102. Additionally or alternatively, the steps shown in FIG. 2 may be performed by a backend server. In one example, each of the steps shown in FIG. 2 may represent an algorithm whose structure includes and/or is represented by multiple sub-steps, examples of which will be provided in greater detail below

At step 202 of FIG. 2, one or more of the systems may determine that a change in a range of frequency, being used by first module 104, has resulted in interference between the changed range of frequency (changed range of frequency 114) and a range of frequency (range of frequency 116) being used by second module 106. The change in range of frequency may be caused by any type of event (e.g., a change in environment, an operational change, etc.). In one embodiment in which first module 104 represents a WiFi module, the change in the range of frequency may be triggered by the WiFi module changing a connection (e.g., to a new WiFi network from a previous WiFi network, where the new WiFi network transmits/receives electromagnetic waves in a different frequency range than the frequency range of the previous WiFi network). Similarly, in an embodiment in which first module 104 represents a Bluetooth module, the change in the range of frequency may be triggered by the Bluetooth module changing a connection (e.g., to a new and/or different external device).

The one or more systems may determine that the change in the range of frequency results in interference in a variety of ways. In some examples, a policy may indicate that the ranges interfere. For example, a policy may define certain ranges as interfering ranges. Additionally or alternatively, the interference may be detected by the one or more systems. In response to determining that first module 104's change in frequency range has resulted in the interference between first module 104 and second module 106, the one or more systems may, at step 204, change the range of frequency being used by second module 106 (e.g., range of frequency 116) to a new range of frequency 118 that does not interfere with first module 104's changed range of frequency 114.

In some cases, changing a module's frequency range can cause a disruption that affects a performance of user device 102 (e.g., a disruption to the operations of the module). To minimize the effects of this disruption, the disclosed poly-module system may configure a timing of second module 104's change in frequency range (e.g., such that second module 104's change in frequency range is executed at a moment in time that minimizes the disruption, negative effects of the disruption, and/or user perception of the disruption).

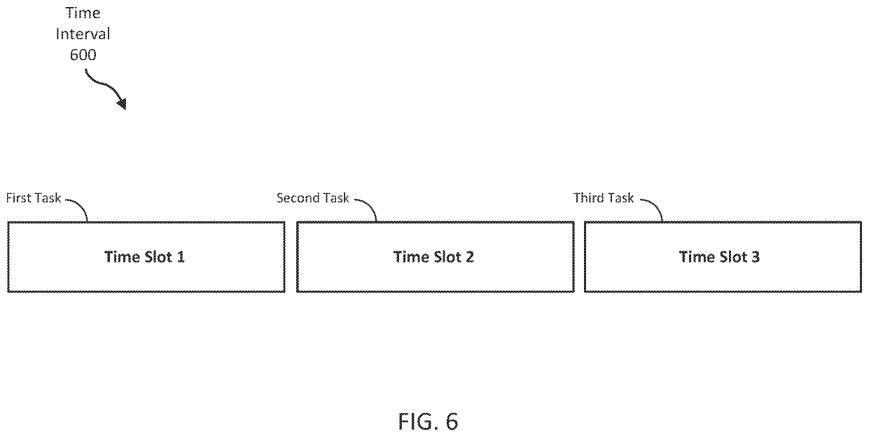

In one such example, user device 102 may be configured to perform multiple repeating tasks such that, within a certain interval of time, a different task is performed at each of multiple time slots within the certain interval of time. A time slot may correspond to any length of time (e.g., five milliseconds, one second, etc.). FIG. 6 depicts an exemplary time interval 600 that includes a first time slot, at which a first task is configured to be performed, a second time slot, at which a second task is configured to be performed, and a third time slot, at which a third task is configured to be performed. (While FIG. 6 depicts a time interval that includes three time slots, it should be appreciated that the disclosed time interval may include any number of time slots). In this example, the one or more systems may identify a time slot, within the certain interval of time, corresponding to a task determined to be the best suited for being disrupted, such as the task whose disruption is determined to have the least impact on a performance of user device 102, relative to one or more of the other tasks (e.g., each of the other tasks) corresponding to one or more of the other time slots. In response to identifying the time slot (e.g., based on the determination regarding the time slot's corresponding task), the one or more systems may change second module 106's frequency range during the identified time slot (instead of changing the frequency range during one of the other time slots). Turning to FIG. 6 as a specific example, the one or more systems may determine that a disruption during the second task may have the least impact on a performance of user device 102. In response, the one or more system may change second module 106's frequency range during time slot 2, instead of during time slot 1 or time slot 3.

The task corresponding to the identified time slot may be determined to have the least impact on the performance of user device 102 in a variety of ways and/or for a variety of reasons. In some examples, changing the frequency range while the task is performed may be shown to decrease a measurable metric of performance less than changing the frequency range while the other tasks (corresponding to the other time slots) are performed. In some examples, a resource requirement for performing the task may be measurably less (e.g., lower) than a resource requirement for performing one or more of the other tasks. In some examples, the task corresponding to the identified time slot may be objectively or subjectively labeled as less important than one or more of the other tasks.

The multiple repeating tasks may represent any type or form of tasks. In one example, second module 106 may represent a camera module and each of the tasks (in the set of repeating tasks) may represent capturing a frame (e.g., an image) intended for a different purpose (e.g., operation), as described previously in connection with the description of the camera module provided in connection with FIG. 1. In one such example, the task corresponding to the identified time slot may represent a frame captured for a keyboard tracking engine and the other tasks may represent frames captured for other types of tracking engines (e.g., a controller tracking engine, a head tracking engine, a hand tracking engine, etc.). In this example, a disruption to keyboard tracking may have been determined to negatively affect an overall (or specific) performance of user device 102 less than a disruption to the other types of tracking (e.g., controller tracking, head tracking, and/or hand tracking). In response to determining that a disruption to keyboard tracking negatively affects the performance of user device 102 less than a disruption to the other types of tracking, the one or more systems may change the range of frequency for second module 106 (e.g., a camera module in this example) while second module 106 is capturing a frame for the keyboard tracking engine (e.g., during the time slot corresponding to second module 106 capturing the frame for the keyboard tracking engine) instead of changing the range of frequency for second module 106 while second module 106 is capturing a frame for the other tracking engines.

In one embodiment, the one or more systems may explicitly determine to not change the range of frequency for second module 106 while certain tasks are being performed (e.g., tasks designated are more important than the identified task). Returning to the specific example just described, in which second module 106 is a camera module, the one or more systems may explicitly determine to not change the range of frequency for second module 106 while second module 106 is capturing frames for controller tracking, head tracking, and/or hand tracking purposes.

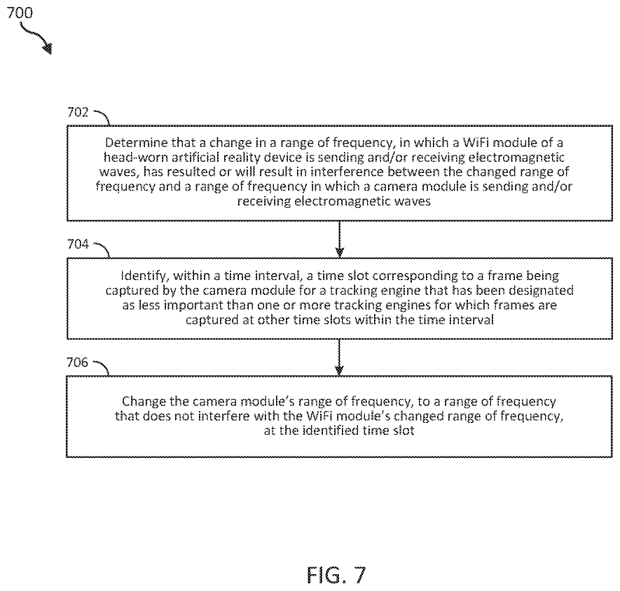

FIG. 7 depicts an exemplary method 700 that implements the method of FIG. 2, according to one specific embodiment. At step 702, one or more of the systems may determine that a change in a range of frequency, in which a WiFi module of a head-worn artificial reality device is sending and/or receiving electromagnetic waves, has resulted or will result in interference between the changed range of frequency and a range of frequency in which a camera module is sending and/or receiving electromagnetic waves. The change may have been executed in response to a variety of triggering events (e.g., a change in WiFi source as described previously). In response to the determining of step 702, the one or more systems may change the camera module's range of frequency, in a manner that minimizes disruption to the operations of the head-worn artificial reality device, by (1) (at step 704) identifying, within a time interval, a time slot corresponding to a frame being captured for a tracking engine that has been designated as less important than one or more tracking engines for which frames are captured at other time slots within the time interval and (2) (at step 706) changing the camera module's range of frequency, to a range of frequency that does not interfere with the WiFi module's changed range of frequency, at the identified time slot (e.g., instead of changing the range of frequency at the other time slots corresponding to the one or more other tracking engines). The steps of method 700 may be implemented using any of the features discussed throughout this application (e.g., in connection with FIGS. 1-6).

In some examples, the disclosed framework may include clustering together modules that need to be changed to a same new range of frequency (e.g., clustering together wireless channels that need the same ideal clock rate for mitigation). For example, one or more of the disclosed systems may reorder a module list (of modules needed to be scanned) so that a module scanner (e.g., a radio scanner) can scan all of the modules with a same ideal range of frequency (clock rate) at once (e.g., prior to moving on to scanning modules with a different ideal range of frequency). This approach may minimize the number of frequency range switches performed during a wireless scan (e.g., reducing the impact on upstream services that rely on the modules being frequency switched).

### EXAMPLE EMBODIMENTS

Example 1. A system including a user device including a first module, which performs a first functionality, and a second module, which performs a second functionality, at least one physical processor, and physical memory including computer-executable instructions that, when executed by the physical processor, cause the physical processor to determine that a change in a range of frequency, being used by the first module, has resulted, or will result, in interference between the first module's changed range of frequency and a range of frequency being used by the second module, and in response to the determining that the change in the range of frequency has resulted in the interference, change the range of the frequency being used by the second module to a new range of frequency that does not interfere with the first module's changed range of frequency.

Example 2. The system of example 1, where the second module is configured to perform multiple repeating tasks such that, within a certain interval of time, the second module performs a different task at each of multiple time slots within the certain interval of time, the processor is further caused to identify a time slot, within the certain of interval time, corresponding to a task whose disruption is determined to have a smaller negative impact, on a performance of the user device, relative to an impact on the performance that would be caused by a disruption to one or more of the tasks corresponding to one or more of the other time slots within the certain interval of time, and changing the range of the frequency being used by the second module includes changing the range of frequency during the identified time slot in response to identifying the corresponding task as the task whose disruption is determined to have the smaller negative impact relative to the impact that would be caused by the disruption to the one or more other tasks.

Example 3. The system of examples 1-2, where the first module includes a WiFi module, and the second module includes a camera module.

Example 4. The system of example 3, where the user device includes a wearable device, and the camera module is configured to capture frames including real world image data.

Example 5. The system of example 4, where the wearable device includes a head-worn artificial reality device.

Example 6. The system of examples 3-4, where within a certain interval of time, including multiple time slots, the camera module is configured to capture multiple frames, each of which is captured at a different time slot within the multiple time slots, each time slot within the multiple time slots corresponds to a different type of operation performed by the user device and each frame is captured as input for the type of operation corresponding to the time slot at which the frame is captured, at a first time slot, within the multiple time slots, the camera module is configured to capture a first frame as an input for a first type of operation corresponding to the first time slot, at a second time slot, within the multiple time slots, the camera module is configured to capture a second frame as an input for a second type of operation corresponding to the second time slot, a disruption to the first type of operation has been determined to affect a performance of the user device less than a disruption to the second type of operation, and changing the range of frequency being used by the second module to the new range of frequency includes changing the range of frequency during the first time slot instead of during the second time slot based on the determination that a disruption to the first type of operation affects the performance of the device less than a disruption to the second type of operation.

Example 7. The system of example 6, where the user device includes a head-worn artificial reality device, the first type of operation includes a first type of tracking corresponding to tracking a first type of entity within a real-world environment of the head-worn artificial reality device, and the second type of operation including a second type of tracking corresponding to tracking a second type of entity within the real-world environment of the head-worn artificial reality device.

Example 8. The system of example 7, where the first type of tracking includes at least one of head tracking, controller tracking, or hand tracking, and the second type of tracking includes keyboard tracking.

Example 9. The system of examples 3-8, where determining the change in the range of frequency, being used by the first module includes, changing the first module's range of frequency to the changed range of frequency as part of a change in WiFi source.

Example 10. A computer-implemented method including determining that a change in a range of frequency, being used by a first module of a user device, has resulted, or will result, in interference between the first module's changed range of frequency and a range of frequency being used by a second module of the user device, in response to the determining that the change in the range of frequency has resulted in the interference, changing the range of the frequency being used by the second module to a new range of frequency that does not interfere with the first module's changed range of frequency.

Example 11. The computer-implemented method of example 10, where the second module is configured to perform multiple repeating tasks such that, within a certain interval of time, the second module performs a different task at each of multiple time slots within the certain interval of time, the method further includes identifying a time slot, within the certain of interval time, corresponding to a task whose disruption is determined to have a smaller negative impact, on a performance of the user device, relative to an impact on the performance that would be caused by a disruption to one or more of the tasks corresponding to one or more of the other time slots within the certain interval of time, and changing the range of the frequency being used by the second module includes changing the range of frequency during the identified time slot in response to identifying the corresponding task as the task whose disruption is determined to have the smaller negative impact relative to the impact that would be caused by the disruption to the one or more other tasks.

Example 12. The computer-implemented method of examples 10-11, where the first module includes a WiFi module, and the second module includes a camera module.

Example 13. The computer-implemented method of example 12, where the user device includes a wearable device, and the camera module is configured to capture frames including real world image data.

Example 14. The computer-implemented method of example 13, where the wearable device includes a head-worn artificial reality device.

Example 15. The computer-implemented method of examples 12-14, where within a certain interval of time, including multiple time slots, the camera module is configured to capture multiple frames, each of which is captured at a different time slot within the multiple time slots, each time slot within the multiple time slots corresponds to a different type of operation performed by the user device and each frame is captured as input for the type of operation corresponding to the time slot at which the frame is captured, at a first time slot, within the multiple time slots, the camera module is configured to capture a first frame as an input for a first type of operation corresponding to the first time slot, at a second time slot, within the multiple time slots, the camera module is configured to capture a second frame as an input for a second type of operation corresponding to the second time slot, a disruption to the first type of operation has been determined to affect a performance of the user device less than a disruption to the second type of operation, and changing the range of frequency being used by the second module to the new range of frequency includes changing the range of frequency during the first time slot instead of during the second time slot based on the determination that a disruption to the first type of operation affects the performance of the device less than a disruption to the second type of operation.

Example 16. The computer-implemented method of example 15, where the user device includes a head-worn artificial reality device, the first type of operation includes a first type of tracking corresponding to tracking a first type of entity within a real-world environment of the head-worn artificial reality device, and the second type of operation including a second type of tracking corresponding to tracking a second type of entity within the real-world environment of the head-worn artificial reality device.

Example 17. The computer-implemented method of example 16, where the first type of tracking includes at least one of head tracking, controller tracking, or hand tracking, and the second type of tracking includes keyboard tracking.

Example 18. The computer-implemented method of examples 12-18, where determining the change in the range of frequency, being used by the first module includes, changing the first module's range of frequency to the changed range of frequency as part of a change in WiFi source.

Example 19. A non-transitory computer-readable medium including one or more computer-readable instructions that, when executed by at least one processor of a computing device, cause the computing device to: determine that a change in a range of frequency, being used by a first module of a user device, has resulted, or will result, in interference between the first module's changed range of frequency and a range of frequency being used by a second module of the user device, and in response to the determining that the change in the range of frequency has resulted in the interference, change the range of the frequency being used by the second module to a new range of frequency that does not interfere with the first module's changed range of frequency.

Example 20. The non-transitory computer-readable medium of example 19, where the second module is configured to perform multiple repeating tasks such that, within a certain interval of time, the second module performs a different task at each of multiple time slots within the certain interval of time, the computing device is further caused to identify a time slot, within the certain of interval time, corresponding to a task whose disruption is determined to have a smaller negative impact, on a performance of the user device, relative to an impact on the performance that would be caused by a disruption to one or more of the tasks corresponding to one or more of the other time slots within the certain interval of time, and changing the range of the frequency being used by the second module includes changing the range of frequency during the identified time slot in response to identifying the corresponding task as the task whose disruption is determined to have the smaller negative impact relative to the impact that would be caused by the disruption to the one or more other tasks.

Example 21: The non-transitory computer-readable medium of examples 19-20, where changing the range of frequency being used by the second module to the new range of frequency includes (1) identifying at least one additional module with an interference predicted to be resolved by a change to the new range of frequency selected for the second module, (2) in response to determining that interference detected for the second module and the additional module are predicted to be resolved by the same new range of frequency, clustering the second module and the additional module together within a list of modules needing a change in frequency range, and (3) updating the second module and the additional module to the new range of frequency during a same time period.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof.

Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 300 in FIG. 3) or that visually immerses a user in an artificial reality (such as, e.g., virtual-reality system 400 in FIG. 4). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 3, augmented-reality system 300 may include an eyewear device 302 with a frame 310 configured to hold a left display device 315(A) and a right display device 315(B) in front of a user's eyes. Display devices 315(A) and 315(B) may act together or independently to present an image or series of images to a user. While augmented-reality system 300 includes two displays, embodiments of this disclosure may be implemented in augmented-reality systems with a single NED or more than two NEDs.

In some embodiments, augmented reality system 300 may include one or more sensors, such as sensor 340. Sensor 340 may generate measurement signals in response to motion of augmented-reality system 300 and may be located on substantially any portion of frame 310. Sensor 340 may represent one or more of a variety of different sensing mechanisms, such as a position sensor, an inertial measurement unit (IMU), a depth camera assembly, a structured light emitter and/or detector, or any combination thereof. In some embodiments, augmented-reality system 300 may or may not include sensor 340 or may include more than one sensor. In embodiments in which sensor 340 includes an IMU, the IMU may generate calibration data based on measurement signals from sensor 340. Examples of sensor 340 may include, without limitation, accelerometers, gyroscopes, magnetometers, other suitable types of sensors that detect motion, sensors used for error correction of the IMU, or some combination thereof.

In some examples, augmented-reality system 300 may also include a microphone array with a plurality of acoustic transducers 320(A)-320(J), referred to collectively as acoustic transducers 320. Acoustic transducers 320 may represent transducers that detect air pressure variations induced by sound waves. Each acoustic transducer 320 may be configured to detect sound and convert the detected sound into an electronic format (e.g., an analog or digital format). The microphone array in FIG. 3 may include, for example, ten acoustic transducers: 320(A) and 320(B), which may be designed to be placed inside a corresponding ear of the user, acoustic transducers 320(C), 320(D), 320(E), 320(F), 320(G), and 320(H), which may be positioned at various locations on frame 310, and/or acoustic transducers 320(I) and 320(J), which may be positioned on a corresponding neckband 305.

In some embodiments, one or more of acoustic transducers 320(A)-(J) may be used as output transducers (e.g., speakers). For example, acoustic transducers 320(A) and/or 320(B) may be earbuds or any other suitable type of headphone or speaker.

The configuration of acoustic transducers 320 of the microphone array may vary. While augmented-reality system 300 is shown in FIG. 3 as having ten acoustic transducers 320, the number of acoustic transducers 320 may be greater or less than ten. In some embodiments, using higher numbers of acoustic transducers 320 may increase the amount of audio information collected and/or the sensitivity and accuracy of the audio information. In contrast, using a lower number of acoustic transducers 320 may decrease the computing power required by an associated controller 350 to process the collected audio information. In addition, the position of each acoustic transducer 320 of the microphone array may vary. For example, the position of an acoustic transducer 320 may include a defined position on the user, a defined coordinate on frame 310, an orientation associated with each acoustic transducer 320, or some combination thereof.

Acoustic transducers 320(A) and 320(B) may be positioned on different parts of the user's ear, such as behind the pinna, behind the tragus, and/or within the auricle or fossa. Or, there may be additional acoustic transducers 320 on or surrounding the ear in addition to acoustic transducers 320 inside the ear canal. Having an acoustic transducer 320 positioned next to an ear canal of a user may enable the microphone array to collect information on how sounds arrive at the ear canal. By positioning at least two of acoustic transducers 320 on either side of a user's head (e.g., as binaural microphones), augmented-reality system 300 may simulate binaural hearing and capture a 3D stereo sound field around about a user's head. In some embodiments, acoustic transducers 320(A) and 320(B) may be connected to augmented-reality system 300 via a wired connection 330, and in other embodiments acoustic transducers 320(A) and 320(B) may be connected to augmented-reality system 300 via a wireless connection (e.g., a BLUETOOTH connection). In still other embodiments, acoustic transducers 320(A) and 320(B) may not be used at all in conjunction with augmented-reality system 300.

Acoustic transducers 320 on frame 310 may be positioned in a variety of different ways, including along the length of the temples, across the bridge, above or below display devices 315(A) and 315(B), or some combination thereof. Acoustic transducers 320 may also be oriented such that the microphone array is able to detect sounds in a wide range of directions surrounding the user wearing the augmented-reality system 300. In some embodiments, an optimization process may be performed during manufacturing of augmented-reality system 300 to determine relative positioning of each acoustic transducer 320 in the microphone array.

In some examples, augmented-reality system 300 may include or be connected to an external device (e.g., a paired device), such as neckband 305. Neckband 305 generally represents any type or form of paired device. Thus, the following discussion of neckband 305 may also apply to various other paired devices, such as charging cases, smart watches, smart phones, wrist bands, other wearable devices, hand-held controllers, tablet computers, laptop computers, other external compute devices, etc.

As shown, neckband 305 may be coupled to eyewear device 302 via one or more connectors. The connectors may be wired or wireless and may include electrical and/or non-electrical (e.g., structural) components. In some cases, eyewear device 302 and neckband 305 may operate independently without any wired or wireless connection between them. While FIG. 3 illustrates the components of eyewear device 302 and neckband 305 in example locations on eyewear device 302 and neckband 305, the components may be located elsewhere and/or distributed differently on eyewear device 302 and/or neckband 305. In some embodiments, the components of eyewear device 302 and neckband 305 may be located on one or more additional peripheral devices paired with eyewear device 302, neckband 305, or some combination thereof.

Pairing external devices, such as neckband 305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 300 may be provided by a paired device or shared between a paired device and an eyewear device, thus reducing the weight, heat profile, and form factor of the eyewear device overall while still retaining desired functionality.

For example, neckband 305 may allow components that would otherwise be included on an eyewear device to be included in neckband 305 since users may tolerate a heavier weight load on their shoulders than they would tolerate on their heads. Neckband 305 may also have a larger surface area over which to diffuse and disperse heat to the ambient environment. Thus, neckband 305 may allow for greater battery and computation capacity than might otherwise have been possible on a stand-alone eyewear device. Since weight carried in neckband 305 may be less invasive to a user than weight carried in eyewear device 302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 305 may be communicatively coupled with eyewear device 302 and/or to other devices. These other devices may provide certain functions (e.g., tracking, localizing, depth mapping, processing, storage, etc.) to augmented-reality system 300. In the embodiment of FIG. 3, neckband 305 may include two acoustic transducers (e.g., 320(I) and 320(J)) that are part of the microphone array (or potentially form their own microphone subarray). Neckband 305 may also include a controller 325 and a power source 335.

Acoustic transducers 320(I) and 320(J) of neckband 305 may be configured to detect sound and convert the detected sound into an electronic format (analog or digital). In the embodiment of FIG. 3, acoustic transducers 320(I) and 320(J) may be positioned on neckband 305, thereby increasing the distance between the neckband acoustic transducers 320(I) and 320(J) and other acoustic transducers 320 positioned on eyewear device 302. In some cases, increasing the distance between acoustic transducers 320 of the microphone array may improve the accuracy of beamforming performed via the microphone array. For example, if a sound is detected by acoustic transducers 320(C) and 320(D) and the distance between acoustic transducers 320(C) and 320(D) is greater than, e.g., the distance between acoustic transducers 320(D) and 320(E), the determined source location of the detected sound may be more accurate than if the sound had been detected by acoustic transducers 320(D) and 320(E).

Controller 325 of neckband 305 may process information generated by the sensors on neckband 305 and/or augmented-reality system 300. For example, controller 325 may process information from the microphone array that describes sounds detected by the microphone array. For each detected sound, controller 325 may perform a direction-of-arrival (DOA) estimation to estimate a direction from which the detected sound arrived at the microphone array. As the microphone array detects sounds, controller 325 may populate an audio data set with the information.

In embodiments in which augmented-reality system 300 includes an inertial measurement unit, controller 325 may compute all inertial and spatial calculations from the IMU located on eyewear device 302. A connector may convey information between augmented-reality system 300 and neckband 305 and between augmented-reality system 300 and controller 325. The information may be in the form of optical data, electrical data, wireless data, or any other transmittable data form. Moving the processing of information generated by augmented-reality system 300 to neckband 305 may reduce weight and heat in eyewear device 302, making it more comfortable to the user.

Power source 335 in neckband 305 may provide power to eyewear device 302 and/or to neckband 305. Power source 335 may include, without limitation, lithium-ion batteries, lithium-polymer batteries, primary lithium batteries, alkaline batteries, or any other form of power storage. In some cases, power source 335 may be a wired power source. Including power source 335 on neckband 305 instead of on eyewear device 302 may help better distribute the weight and heat generated by power source 335.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 400 in FIG. 4, that mostly or completely covers a user's field of view. Virtual-reality system 400 may include a front rigid body 402 and a band 404 shaped to fit around a user's head. Virtual-reality system 400 may also include output audio transducers 406(A) and 406(B). Furthermore, while not shown in FIG. 4, front rigid body 402 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 300 and/or virtual-reality system 400 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 300 and/or virtual-reality system 400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 300 and/or virtual-reality system 400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world.

Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., physical memory 110 in FIG. 1) and at least one physical processor (e.g., physical processor 108 in FIG. 1).

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

User interfaces corresponding to the methods and systems described above may be surfaced as part of a variety of navigational flows. In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

Each of the computer-mediated actions described herein may be performed by a module that operates within an endpoint device (e.g., user device 102) and/or that operates within a backend server. In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server). In examples in which a module performs an action indirectly, the module may perform the action in a variety of ways. For example, the module may perform the action by instructing the endpoint device to perform the action, by transmitting content to the endpoint device to be presented by the endpoint device, by providing the endpoint with an application that performs the action, by receiving an indication of user input to the endpoint device from the endpoint device, etc. Additionally, in some examples, the module may perform an action operating in a combination of an endpoint device and a backend server.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a user device comprising a first module, which performs a first functionality, and a second module, which performs a second functionality;
at least one physical processor; and
physical memory comprising computer-executable instructions that, when executed by the physical processor, cause the physical processor to:
determine that a change in a range of frequency, being used by the first module, has resulted, or will result, in interference between the first module's changed range of frequency and a range of frequency being used by the second module; and
in response to the determining that the change in the range of frequency has resulted in the interference, change the range of the frequency being used by the second module to a new range of frequency that does not interfere with the first module's changed range of frequency.

2. The system of claim 1, wherein:
the second module is configured to perform a plurality of repeating tasks such that, within a certain interval of time, the second module performs a different task at each of multiple time slots within the certain interval of time;
the processor is further caused to identify a time slot, within the certain of interval time, corresponding to a task whose disruption is determined to have a smaller negative impact, on a performance of the user device, relative to an impact on the performance that would be caused by a disruption to one or more of the tasks corresponding to one or more of the other time slots within the certain interval of time; and
changing the range of the frequency being used by the second module comprises changing the range of frequency during the identified time slot in response to identifying the corresponding task as the task whose disruption is determined to have the smaller negative impact relative to the impact that would be caused by the disruption to the one or more other tasks.

3. The system of claim 1, wherein:
the first module comprises a WiFi module; and
the second module comprises a camera module.

4. The system of claim 3, wherein:
the user device comprises a wearable device; and
the camera module is configured to capture frames comprising real world image data.

5. The system of claim 4, wherein the wearable device comprises a head-worn artificial reality device.

6. The system of claim 3, wherein:
within a certain interval of time, comprising a plurality of time slots, the camera module is configured to capture a plurality of frames, each of which is captured at a different time slot within the plurality of time slots;
each time slot within the plurality of time slots corresponds to a different type of operation performed by the user device and each frame is captured as input for the type of operation corresponding to the time slot at which the frame is captured;
at a first time slot, within the plurality of time slots, the camera module is configured to capture a first frame as an input for a first type of operation corresponding to the first time slot;
at a second time slot, within the plurality of time slots, the camera module is configured to capture a second frame as an input for a second type of operation corresponding to the second time slot;
a disruption to the first type of operation has been determined to affect a performance of the user device less than a disruption to the second type of operation; and
changing the range of frequency being used by the second module to the new range of frequency comprises changing the range of frequency during the first time slot instead of during the second time slot based on the determination that a disruption to the first type of operation affects the performance of the device less than a disruption to the second type of operation.

7. The system of claim 6, wherein:
the user device comprises a head-worn artificial reality device;
the first type of operation comprises a first type of tracking corresponding to tracking a first type of entity within a real-world environment of the head-worn artificial reality device; and
the second type of operation comprising a second type of tracking corresponding to tracking a second type of entity within the real-world environment of the head-worn artificial reality device.

8. The system of claim 7, wherein:
the first type of tracking comprises at least one of head tracking, controller tracking, or hand tracking; and
the second type of tracking comprises keyboard tracking.

9. The system of claim 3, wherein determining the change in the range of frequency, being used by the first module comprises, changing the first module's range of frequency to the changed range of frequency as part of a change in WiFi source.

10. A computer-implemented method comprising:
determining that a change in a range of frequency, being used by a first module of a user device, has resulted, or will result, in interference between the first module's changed range of frequency and a range of frequency being used by a second module of the user device;
in response to the determining that the change in the range of frequency has resulted in the interference, changing the range of the frequency being used by the second module to a new range of frequency that does not interfere with the first module's changed range of frequency.

11. The computer-implemented method of claim 10, wherein:
the second module is configured to perform a plurality of repeating tasks such that, within a certain interval of time, the second module performs a different task at each of multiple time slots within the certain interval of time;
the method further comprises identifying a time slot, within the certain of interval time, corresponding to a task whose disruption is determined to have a smaller negative impact, on a performance of the user device, relative to an impact on the performance that would be caused by a disruption to one or more of the tasks corresponding to one or more of the other time slots within the certain interval of time; and
changing the range of the frequency being used by the second module comprises changing the range of frequency during the identified time slot in response to identifying the corresponding task as the task whose disruption is determined to have the smaller negative impact relative to the impact that would be caused by the disruption to the one or more other tasks.

12. The computer-implemented method of claim 10, wherein:
the first module comprises a WiFi module; and
the second module comprises a camera module.

13. The computer-implemented method of claim 12, wherein:
the user device comprises a wearable device; and
the camera module is configured to capture frames comprising real world image data.

14. The computer-implemented method of claim 13, wherein the wearable device comprises a head-worn artificial reality device.

15. The computer-implemented method of claim 12, wherein:
within a certain interval of time, comprising a plurality of time slots, the camera module is configured to capture a plurality of frames, each of which is captured at a different time slot within the plurality of time slots;
each time slot within the plurality of time slots corresponds to a different type of operation performed by the user device and each frame is captured as input for the type of operation corresponding to the time slot at which the frame is captured;
at a first time slot, within the plurality of time slots, the camera module is configured to capture a first frame as an input for a first type of operation corresponding to the first time slot;
at a second time slot, within the plurality of time slots, the camera module is configured to capture a second frame as an input for a second type of operation corresponding to the second time slot;
a disruption to the first type of operation has been determined to affect a performance of the user device less than a disruption to the second type of operation; and
changing the range of frequency being used by the second module to the new range of frequency comprises changing the range of frequency during the first time slot instead of during the second time slot based on the determination that a disruption to the first type of operation affects the performance of the device less than a disruption to the second type of operation.

16. The computer-implemented method of claim 15, wherein:
the user device comprises a head-worn artificial reality device;
the first type of operation comprises a first type of tracking corresponding to tracking a first type of entity within a real-world environment of the head-worn artificial reality device; and
the second type of operation comprising a second type of tracking corresponding to tracking a second type of entity within the real-world environment of the head-worn artificial reality device.

17. The computer-implemented method of claim 16, wherein:
the first type of tracking comprises at least one of head tracking, controller tracking, or hand tracking; and
the second type of tracking comprises keyboard tracking.

18. The computer-implemented method of claim 12, wherein determining the change in the range of frequency, being used by the first module comprises, changing the first module's range of frequency to the changed range of frequency as part of a change in WiFi source.

19. A non-transitory computer-readable medium comprising one or more computer-readable instructions that, when executed by at least one processor of a computing device, cause the computing device to:
determine that a change in a range of frequency, being used by a first module of a user device, has resulted, or will result, in interference between the first module's changed range of frequency and a range of frequency being used by a second module of the user device; and
in response to the determining that the change in the range of frequency has resulted in the interference, change the range of the frequency being used by the second module to a new range of frequency that does not interfere with the first module's changed range of frequency.

20. The non-transitory computer-readable medium of claim 19, wherein changing the range of frequency being used by the second module to the new range of frequency comprises:
identifying at least one additional module with an interference predicted to be resolved by a change to the new range of frequency selected for the second module; and
in response to determining that interference detected for the second module and the additional module are predicted to be resolved by the same new range of frequency, clustering the second module and the additional module together within a list of modules needing a change in frequency range; and
updating the second module and the additional module to the new range of frequency during a same time period.
